(19) United States
(12) Patent Application Publication
(10) Pub. No.: US 2018/0114454 A1
(43) Pub. Date: Apr. 26, 2018

(54) Process and system to limit access until a desired educational activity has been performed

(71) Applicant: Raffi Rajabian, Brooklyn, NY (US)

(72) Inventor: Raffi Rajabian, Brooklyn, NY (US)

(21) Appl. No.: 15/333,269

(22) Filed: Oct. 25, 2016

(51) Int. Cl. G09B 7/00; G09B 17/00; G09B 19/00; G09B 19/02

(52) U.S. Cl. CPC G09B 7/00; G09B 17/00; G09B 19/0023; G09B 19/02; G09B 19/0046

(57) ABSTRACT

This current invention is a system and application that requires a people like children to solve puzzles, or learn about history or math before they can play games or use a web browser. The system would work like a smartphone application, this product would be available through the respective marketplace for smartphones. It allows parents to select certain applications (such as netflix, angry birds, etc.) to prompt the application before they open.

### CROSS-REFERENCES TO RELATED APPLICATIONS (IF ANY)

None

### BACKGROUND

### 1. Field of the Invention

The present invention relates to a process to limit access until a desired criteria have been met in particular testing based on grade.

### 2. Description of Prior Art

Currently, there are no applications or prior art that limit a child's access to media or multi-media content based on testing. There were a number of educational based apps available for a wide range of children. Most focus on older students who are currently enrolled in school and most are in the form of games or other educational based challenges to help the student improve their overall educational scores.

As far as an app, which specifically utilizes password games for the student to access other app or computer programs, there are none in current art.

There is still room for improvement in the art.

### SUMMARY OF THE INVENTION

The current invention is system and application that requires people like children to solve puzzles, or learn about history or math before they can play games or use a web browser.

The system, in the preferred embodiment, would work like a smartphone application, this product would be available through the respective marketplace for smartphones.

The process would be that a user would register and login. It is a smartphone app. It allows parents to select certain applications (such as netflix, angry birds, etc.) to prompt the application before they open.

So, a child picks up the phone, clicks Netflix but the system opens up first and requires the child to take a quiz over various subjects. They have to pass the quiz before the app can be closed out.

The innovative process is more efficient, effective, accurate and functional than the current art.

### BRIEF DESCRIPTION OF THE DRAWINGS

Without restricting the full scope of this invention, the preferred form of this invention is illustrated in the following drawings:

FIG. 1 shows an overview of how Users access the system;

FIG. 2 shows a sample of a login screen;

FIG. 3 shows a profile screen;

FIG. 4 displays the settings screen;

FIG. 5 displays the subjects screen;

FIG. 6 displays the review and start system;

FIG. 7 shows a sample question screen; and

FIG. 8 displays the properties rented;

FIG. 9 shows a sample ending screen; and

FIG. 10 shows a logic flow.

### DESCRIPTION OF THE PREFERRED EMBODIMENT

There are a number of significant design features and improvements incorporated within the invention.

The current invention is system and application that requires people like children to solve puzzles, or learn about history or math before they can play games or use a web browser.

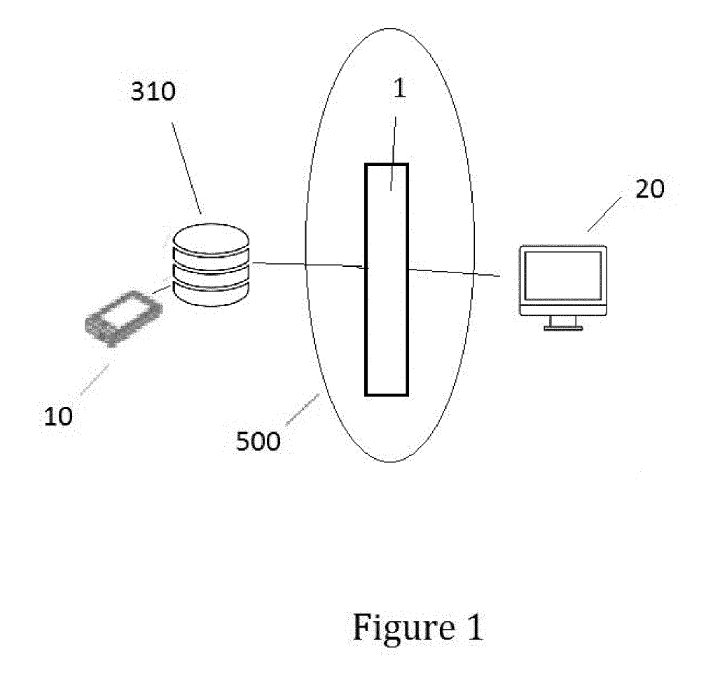

FIG. 1 displays the preferred embodiment of the system architecture 1 accessed through an Internet, Intranet and/or Wireless network 500. However, the system could be implemented on a device-to-device or client/server architecture as well.

In FIG. 1, the system 1 is accessed from a user's computing device 10 through a web browser over HTTP and/or HTTPS protocols 500 or wireless network or cell phone to cell phone connection. A computing device 20, such as a smart phone, that can access the system 1 must have some version of a CPU, CPU memory, local hard disk, keyboard/keypad/input and display unit. The computing device 20 can be any desktop, laptop, tablet, smart phone or general purpose computing device with an appropriate amount of memory suitable for this purpose and an active connection to the Internet 500. Computing devices like this are well known in the art and are not pertinent to the invention.

The system 1, data and processing code can reside in the non-transitory memory 310 of the one or more computing devices. The system 1 in the preferred embodiment would be written to act like a smart phone application (app) where the different apps can communicate with each. The system 1 may work with a central server as shown in FIG. 1 or in parallel which each computing device 10 or smartphone communicating with others within the system 1.

The system 1, data and processing code can reside in the non-transitory memory 310 of the one or more computing devices. The system 1 in the preferred embodiment would be written to act like a smart phone application (app).

### BRIEF OVERVIEW

This current invention is a system 1 and application that requires people like children to solve puzzles, or learn about history or math before they can play games or use a web browser. It requires the users to earn their usage time by reading, learning and/or testing on what they know and learn.

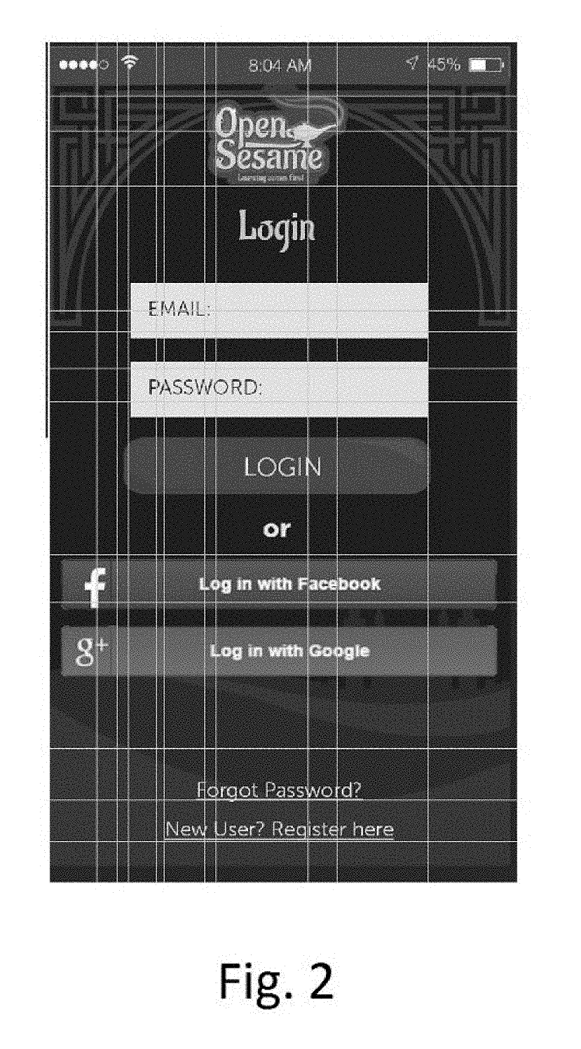

The users would sign-in directly or using social logins as shown in FIG. 2 with the user registering the app,

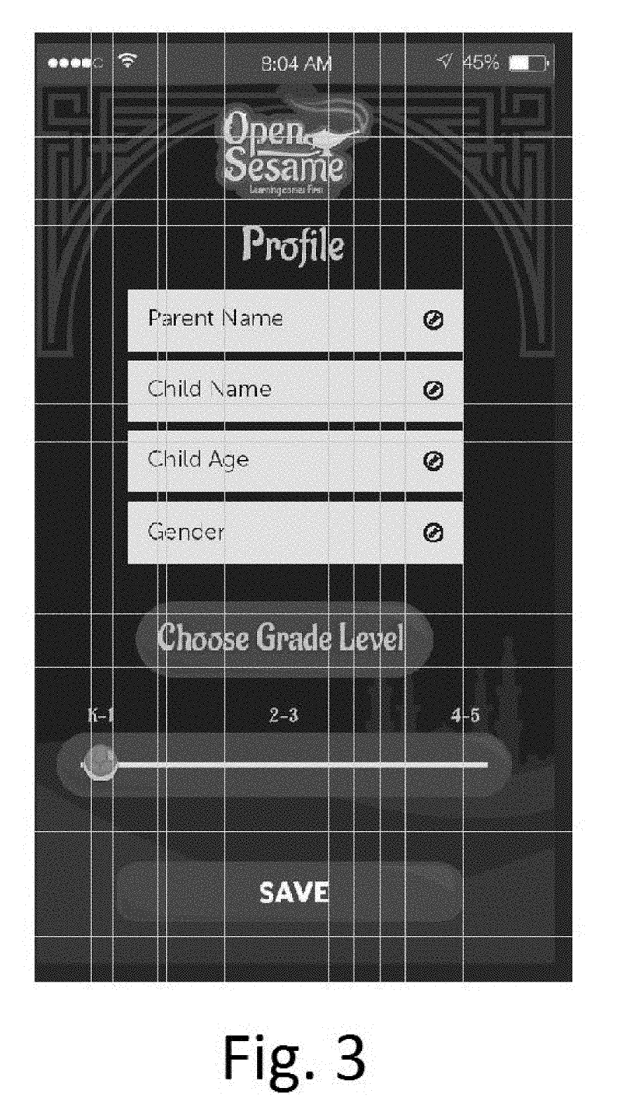

The user will set up their profile for the system using the profile screen as shown in FIG. 3. The profile screen could ask information from the user like parent name, child's name, child's age and gender. The system 1 could have other profile questions or inputs depending on desires of the user. The screen shows a slide bar in which the user sets up the desired grade level for the level of questions, education gaming, reading or testing.

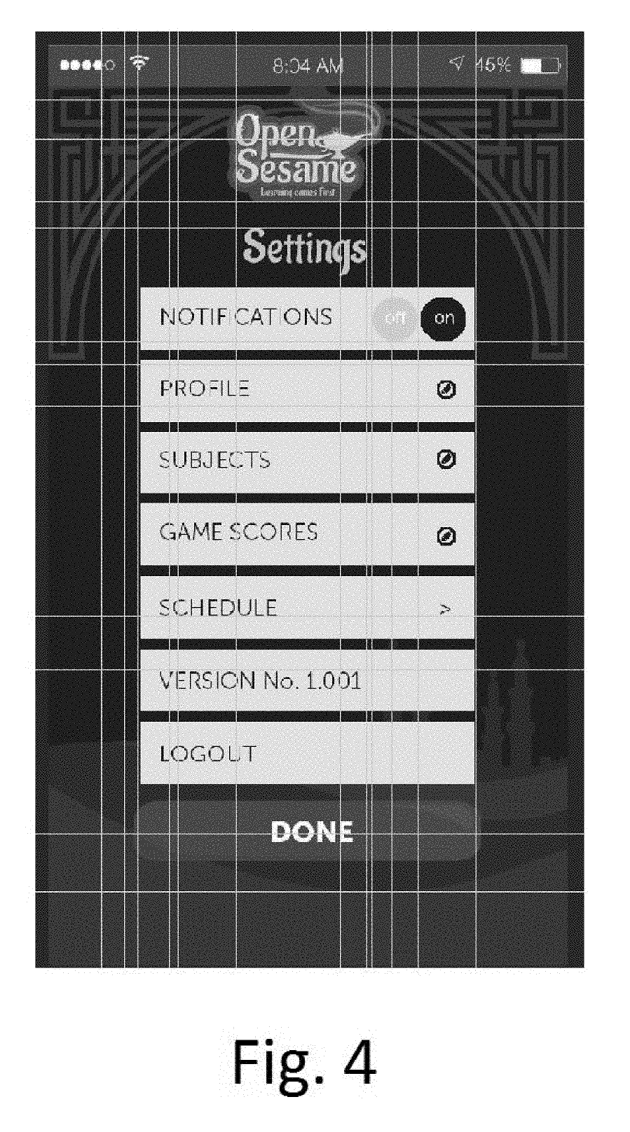

The user will set setting details as shown in FIG. 4. The user will set notification, the profile, the subject desired to be learned or testing to unlock the media or media device, the game scores, schedule when the user when user want access and how much time access, the version and a logout function.

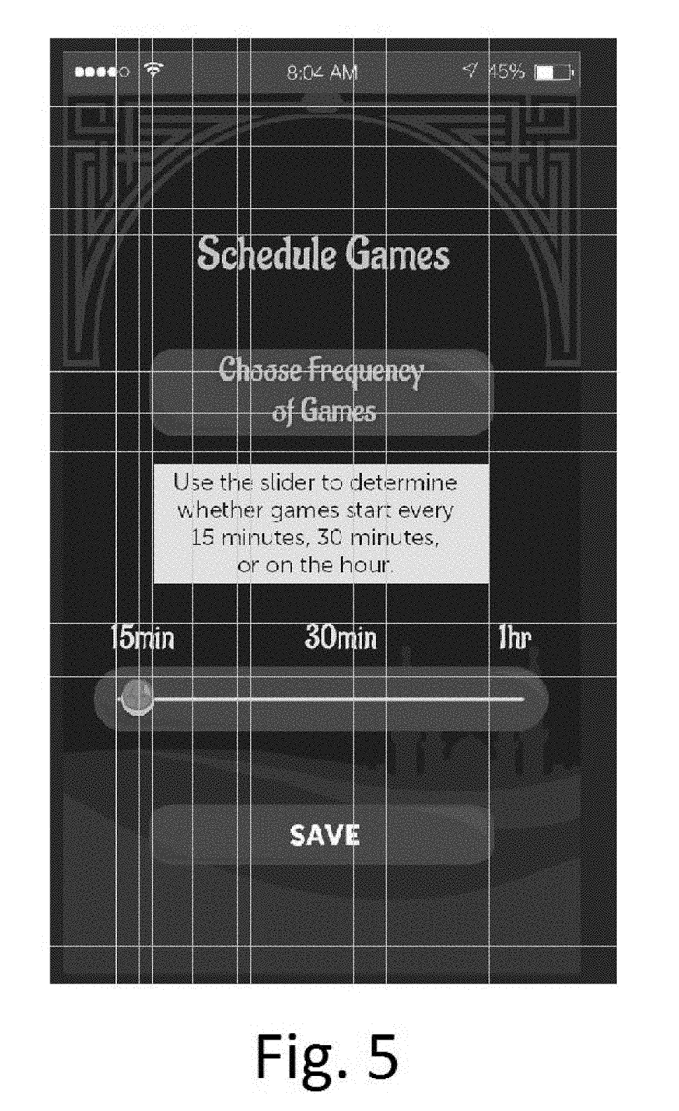

FIG. 5 displays the schedule games screen which can be selected from the settings screen as shown in FIG. 4. The user can use this screen to chose the frequency of education games, tests or reading requirements. In the preferred embodiment it has a slider bar that allows the user to determine whether the games start every 10 minutes, 15 minutes, 30 minutes or customized time. These time amounts can be changed by the user to meet the users' needs and desires.

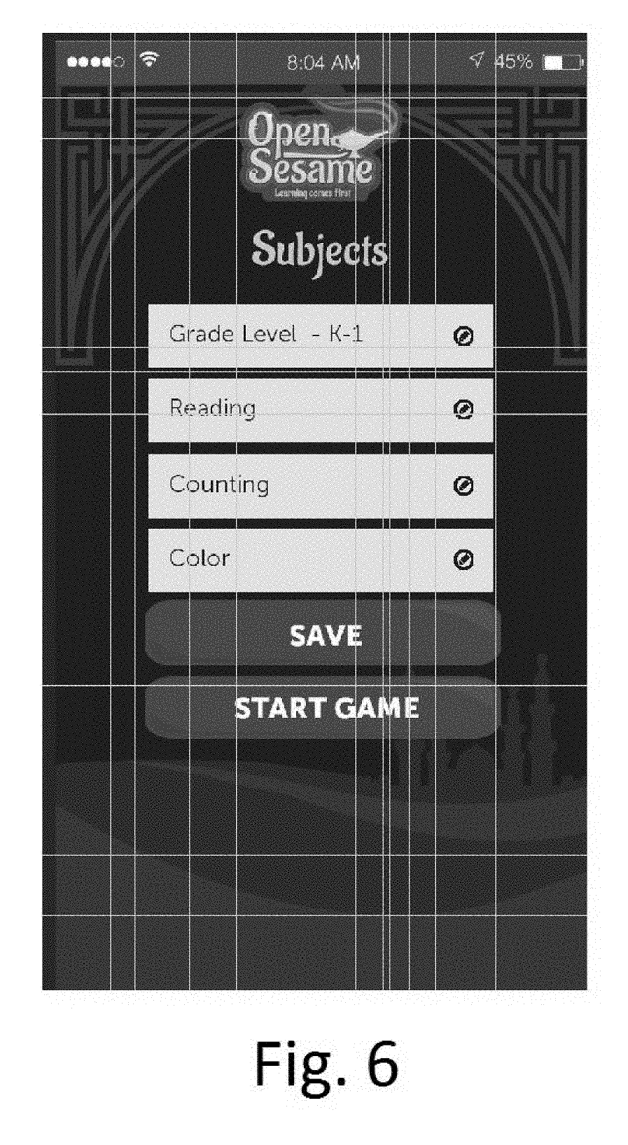

FIG. 6 displays a sample subjects screen, which also can be reached by a link in the settings screen. The subjects screen should the set grade level and allows the user to choose the subjects that the user wants the child or person tested on before getting access to the media or multi-media device. FIG. 6 shows a grade level of kindergarten to first grade with the subjects being reading, counting and color. This could easily be algebra, world history and biology for older students or even project management and business ethics for adults. A user can set the system 1 up for themselves for self testing if desired. In the preferred embodiment, the subjects screen would have the start game tab but this tab can also be on its own screen and/or other screens.

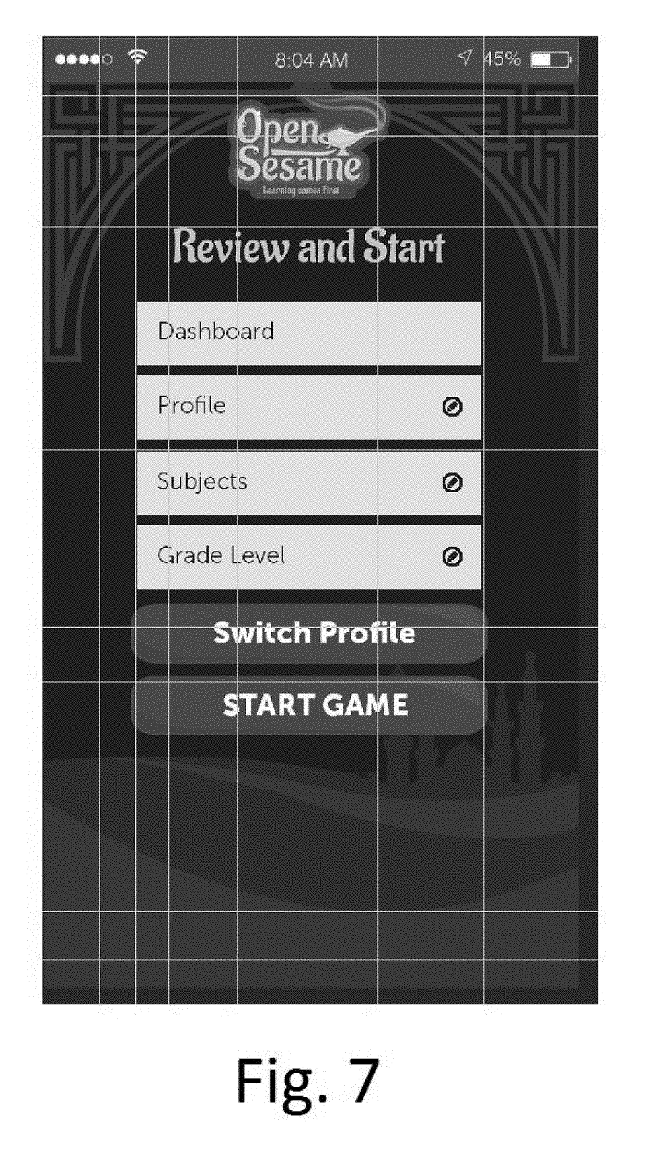

FIG. 7 displays a review and start screen. It allows the user to review their choices and inputs, reset them if desired and start the game or choose another profile which can be another child, set of subject matter or person. This screen also has a start tab.

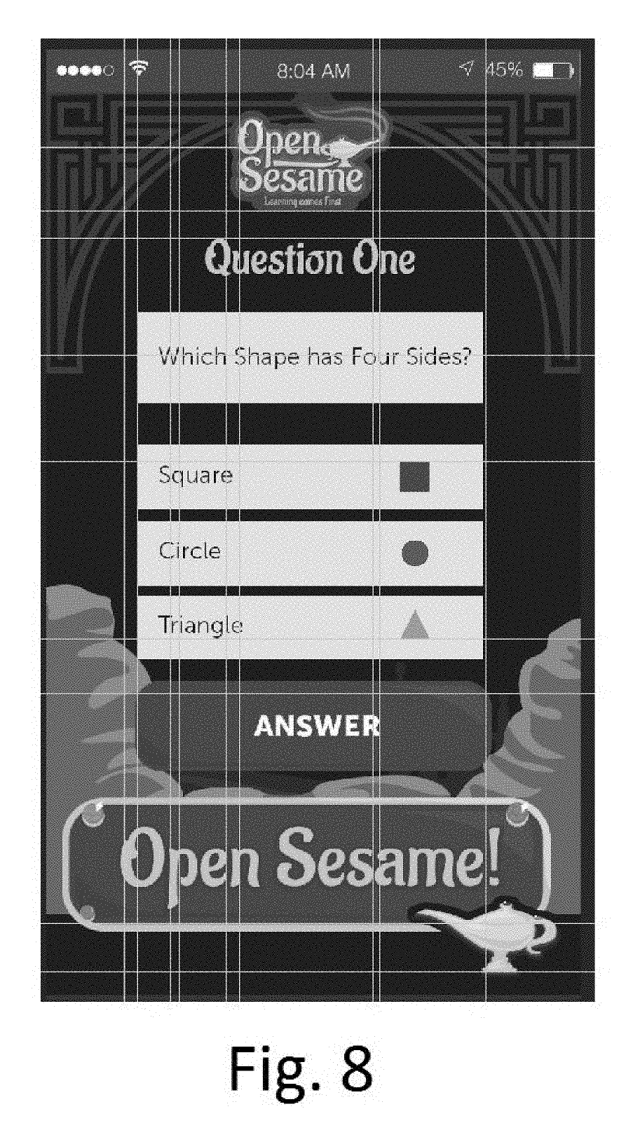

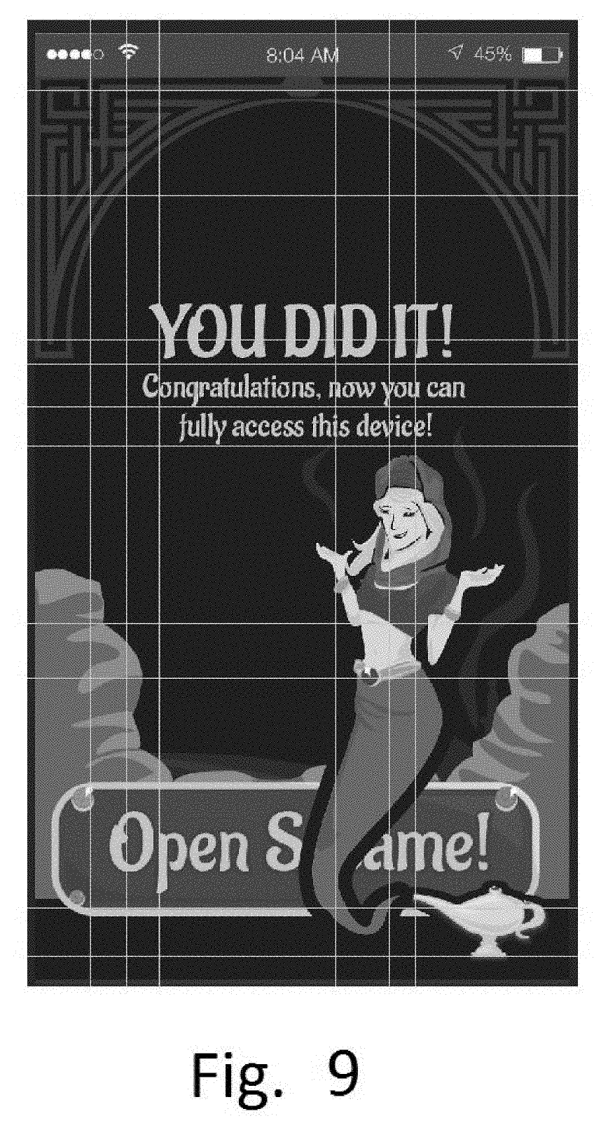

FIG. 8 shows a sample question screen. This one is for a younger child with a question about shapes. The answer is set in a multiple choice style with the child selecting the tab with the right answer to move forward. The number of questions before the system 1 allows access can be set by the user. It can be one or more questions. When the proper desired number is reached that system 1 will give the child or person access to their desired media or multi-media device such as a video streaming service or online game or even television. FIG. 9 displays the success screen which appears when all the questions have been successfully answered.

### Operation

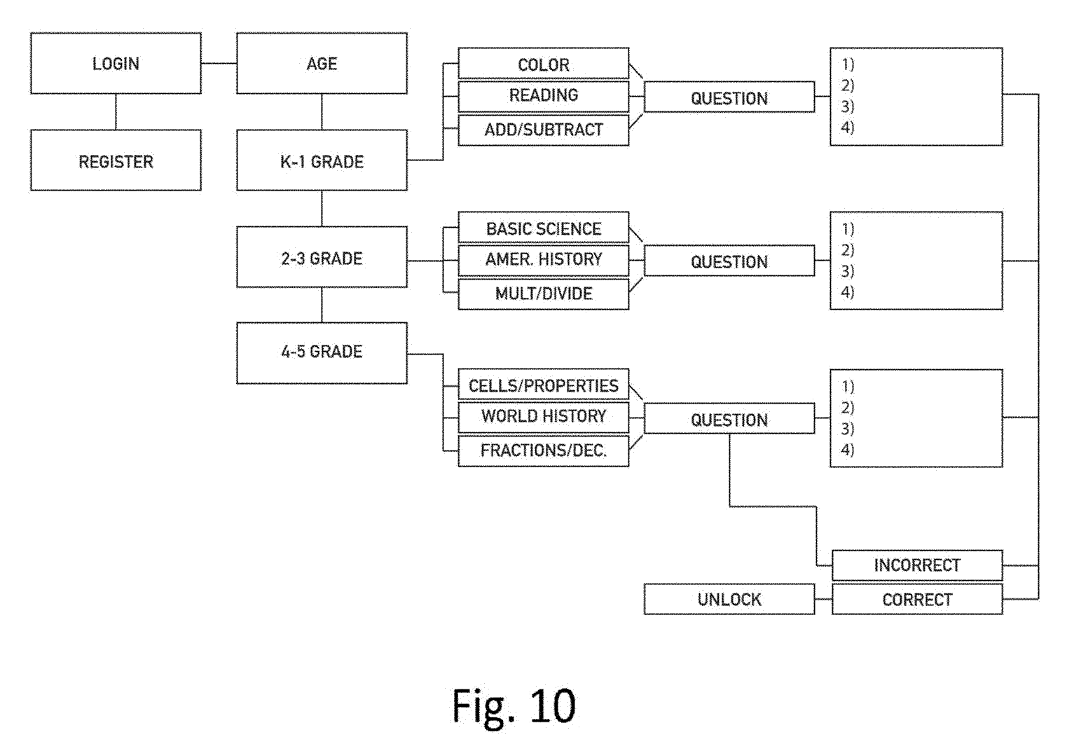

FIG. 10 shows a flowchart of the system 1.

A user would login, if it is their first time using the system 1 they would register. The user would input the age of the person to use the system 1 and select or input the desired grade level such as Kindergarten through first, second through third, fourth through fifth and on up until even college or work age. The user would select the desired subject matter desired by the user for child or person who's access is being controlled. The subjects would be appropriate for the grade selected by the user. Based on the subjects and grade levels, the system 1 would choose a set of questions to be answered to unlock the media or multi-media device. The child or person would have to answer a set number of questions correct to unlock access. This is shown in FIG. 11 where the media is locked behind the system 1 until the proper number of questions are answered correctly.

Access can also be set to be denied once the child or person has reach a certain amount of access time. The can be reset by either the passage of an amount of time or meeting a criteria such as the number of correct questions. This allows the system 1 to limit the amount of access for any given timeframe like during a day or 24 hour period.

### CONCLUSION

The system 1 can be used to limit access to any media, media device or electronic game or device such a video streaming service, internet connection, gaming device, television, computer, smartphone, social media sites or anything similar in which a user desires to limit access.

Although the present invention has been described in considerable detail with reference to certain preferred versions thereof, other versions are possible. Therefore, the point and scope of the appended claims should not be limited to the description of the preferred versions contained herein. The system is not limited to any particular programming language, computer platform or architecture.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A system comprising;
having a system that resides in the non-transitory memory of a computing device;
preventing access until a select criteria is met;
meeting said criteria; and
allowing access.

2. A system according to claim 1 preventing access to a media.

3. A system according to claim 1 preventing access to a multi-media device.

4. A system according to claim 1 where the criteria is the correct answering of questions.

5. A system according to claim 4 inputting a grade level and having the questions be based on that grade level.

6. A system according to claim 5 selecting subjects and having the questions be based on those subjects.

7. A system according to claim 5 having selecting the number of questions to be answered to unlock the access.

8. A system according to claim 1 having a user logon to the system.

9. A system according to claim 8 having the user set the criteria.

10. A system according to claim 9 having the criteria be answering questions correctly.

11. A system according to claim 1 having the user input a grade level and having the questions be based on that grade level.

12. A system according to claim 11 having the user set the number of questions correct to allow access.

13. A system according to claim 12 allowing access once the set number of questions have been accessed correctly.

14. A system according to claim 1 setting access for a set period of time.

15. A system according to claim 14 denying access after set period of access time.

16. A system according to claim 14 after set period of time deny access until the criteria has been met again.

17. A system comprising;
having a system that resides in the non-transitory memory of a computing device;
inputting a grade level;
asking questions based on that grade level;
setting a select criteria based on the number of correctly answered question;
preventing access until the select criteria is met;
meeting said criteria; and
allowing access.

18. A system according to claim 17 preventing access to a media.

19. A system according to claim 17 selecting subjects and having the questions be based on those subjects.

20. A system according to claim 117 after set period of time deny access.
